(19) United States
(12) Patent Application Publication
(10) Pub. No.: US 2004/0162993 A1
(43) Pub. Date: Aug. 19, 2004

(54) Antifraud method of an algorithm executed by an integrated circuit

(76) Inventor: Yannick Teglia, Marseille (FR)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/776,415

(22) Filed: Feb. 11, 2004

(30) Foreign Application Priority Data
Feb. 13, 2003 (FR) 03/01783

(51) Int. Cl. G06F 12/14

(52) U.S. Cl. 713/200

(57) ABSTRACT

An antifraud method including randomizing the physical signature of an integrated circuit executing a main program, including providing in the main program a branch to a randomly-chosen address of a sub-program having at least the feature that any operation code that it contains directly or indirectly leads to an instruction included in the same sub-program except for at least one instruction for returning to the main program, to randomize the total execution time of the main program.

### BACKGROUND OF THE INVENTION

1. Field of the Invention

The present invention relates to the field of integrated circuits and, more specifically, to the protection of data or secret quantities processed by integrated circuits against fraud attempts aiming at pirating these data.

2. Discussion of the Related Art

An example of an application of the present invention relates to the field of smart cards in which secret quantities used to cipher or encrypt data coming from the outside are contained in the integrated circuit chip.

Among possible frauds, the present invention is more specifically concerned with fraud attempts based on an examination of the signature of a physical parameter of the integrated circuit executing a function involving a secret quantity. This physical signature on the integrated circuit may correspond, for example, to the variation of its temperature or of its current consumption. Attacks by statistical analysis of the current consumption of an integrated circuit are known as SPA (simple power analysis) or DPA (differential power analysis) attacks. Such attacks consist of making hypotheses about the handled key(s) while the data input into the algorithm (coming from the outside) and the algorithm itself are known. Since the algorithm is known (it is deterministic, in that it always processes the data in the same way), the way in which the secret quantity is mixed with the input data by this algorithm is known. By varying the input data on the basis of a same key hypothesis, the current consumption of the circuit can be analyzed and an average signature (trace), which can lead to the discovery of the secret quantity by determining the right hypothesis, can be obtained.

DPA-type current consumption attacks are described, for example, in an article “Differential Power Analysis” by Kocher, Jaffe, and Jun, published by Springer Verlag LNCS 1666, in 1999, in the context of the CRYPTO 99 conference (pages 388-397).

A security defect of integrated circuits, for example, smart cards, executing algorithms processing secret quantities, causes considerable prejudice to the development of products integrating such systems.

### SUMMARY OF THE INVENTION

The present invention aims at improving the security of integrated circuits processing secret data against physical signature analysis attacks. More specifically, the present invention aims at providing an anti-fraud method against attacks by physical signature analysis of an integrated circuit processing secret data.

To achieve these and other objects, the present invention provides an antifraud method comprising randomizing the physical signature of an integrated circuit executing a main program, comprising providing in the main program a branch to a randomly-chosen address of a sub-program having at least the features that any operation code that it contains directly or indirectly leads to an instruction included in the same sub-program except for at least one instruction for returning to the main program, and that whatever the input address in this sub-program, the execution of said instruction for returning returns to the main calling program (Pg) at the instruction immediately following the instruction having caused said branching to the sub-program, to randomize the total execution time of the main program.

According to an embodiment of the present invention, the sub-program has a feature that whatever the input address in this sub-program, the instruction for returning to the main calling program is necessarily reached.

According to an embodiment of the present invention, the sub-program has a feature of containing no interrupt-generating operation code.

According to an embodiment of the present invention, the sub-program has a feature of containing no instruction for jumping or branching to an address external to the sub-program.

According to an embodiment of the present invention, the sub-program has a feature of containing no infinite loop.

According to an embodiment of the present invention, the sub-program is placed, with the code of the main program, in a ROM.

The present invention also provides an integrated circuit for executing a deterministic program.

### BRIEF DESCRIPTION OF THE DRAWINGS

The foregoing objects, features, and advantages of the present invention will be discussed in detail in the following non-limiting description of specific embodiments in connection with the accompanying drawing, which very schematically illustrates an embodiment of the antifraud method according to the present invention.

### DETAILED DESCRIPTION

For clarity, only those elements that are necessary to the understanding of the present invention have been shown in the drawings and will be described hereafter. In particular, the structure of an integrated circuit or microcontroller executing a security function of the present invention has not been detailed, since the present invention may be implemented with any known microcontroller. Further, the instructions and operation codes used to implement the security sub-program of the present invention have not been detailed, since this sub-program implementing instruction is conventional per se.

A feature of the present invention is to provide a desynchronization of a program or algorithm processing secret quantities in order to randomize its execution time. Thus, from one execution to another, the physical signature of the circuit is randomly different, which prevents a possible pirate from validating a hypothesis about the secret quantity, since the signature difference does not result solely from a difference between input data.

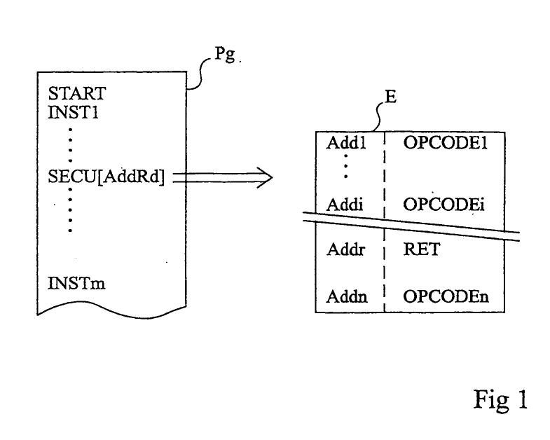

FIG. 1 very schematically illustrates an embodiment of the antifraud method of the present invention.

The present invention applies, in this example, to a program Pg processing secret quantities. This program starts with a start instruction (START), and comprises a succession of instructions INST1 to INSTm conventionally executing the algorithm.

According to a feature of the present invention, program Pg comprises at least one instruction for branching to a sub-program E. This instruction has been designated as SECU. Instruction SECU comprises a branch to sub-program E at a randomly-selected address AddRd.

Thus, when the program executes instruction SECU, the microcontroller performs a random selection of a number Rd between two values forming the address terminals of sub-program E. Branch address Addi (i corresponds to random number Rd) in sub-program E is thus random and changes at each execution of algorithm Pg.

Sub-program E contains operation codes OPCODEi which are, according to the present invention, chosen from a set of codes fulfilling the following conditions:

operation codes OPCODEi belong to a closed set, that is, whatever the operation code executed in sub-program E (except for an instruction RET for returning to the calling program Pg), the next operation code is also an operation code of this sub-program;

the possible instructions for jumping or calling other sub-programs are preferably limited to those enabling respecting the closed set;

whatever the input address in sub-program E, operation code RET which enables exiting the program is always finally encountered;

sub-program E has no infinite loops; and

preferably, the set of operation codes contains no interrupt-generation instruction (to avoid stopping of the algorithm execution).

The sub-program components have been designated hereabove as being operation codes, above all to distinguish them from the main program instructions. In practice, sub-program E contains, like any program, instructions each formed of one or several operation codes processing, according to cases, one or several operands. The accesses in sub-program E can thus be performed at beginnings of instructions respecting the above-discussed conditions. What matters is not to fall in the middle of an instruction (on an operation code of a complex instruction) and to remain blocked therein. For the case where some addresses of sub-program E are forbidden in terms of input address, a validation test of random number Rd will for example be performed. As an alternative, number Rd is randomly chosen from a set of possible addresses.

For the case where the instructions or operation codes of the sub-program use operands, said operands may be any operands except for the actual possible secret quantity.

Sub-program E is, for example, housed in a ROM with the code of main program Pg.

The generation of antifraud sub-program E may be performed manually, if the above-discussed conditions are fulfilled.

According to another embodiment, program E is automatically generated by a compiler. The user thus has the guarantee that the conditions are fulfilled on this sub-program. The sub-program then is a set of operation codes generated automatically, possibly randomly, while complying with the predefined rules.

Of course, several calls to antifraud function SECU may be present in main program Pg. Similarly, different sub-programs E may be provided, provided that each of them is of same nature and respects the random access from the main program.

As a simplified example, the simplest sub-program consists of positioning instruction RET at the last line of the sub-program and of only providing instructions or operation code NEXT for jumping to the next address. Thus, according to the address to which instruction SECU of the main program sends in the sub-program, the time to reach return instruction RET is different.

An advantage of the present invention is that it enables randomizing the execution time of a program processing secret quantities. This enables making variable and random the current signature (or another physical signature) of the integrated circuit executing this program.

Of course, the present invention is likely to have various alterations, modifications, and improvements which will readily occur to those skilled in the art. In particular, the selection of the operation codes authorized for security sub-program E is within the abilities of those skilled in the art based on the functional indications given hereabove. Further, adapting the present invention to the different programming languages based on these indications is within the abilities of those skilled in the art. It is enough to provide, in the usable instructions, a specific instruction (SECU) which uses the set of operation codes or sub-program specific to the present invention.

Further, the security sub-program may contain instructions for jumping to another sub-program, be it or not deterministic, provided that it is directly or indirectly returned to the main program.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. An antifraud method comprising randomizing a physical signature of an integrated circuit executing a main program, comprising providing in said main program a branch to a randomly-chosen address of a sub-program having at least a features that any operation code that it contains directly or indirectly leads to an instruction included in the same sub-program except for at least one instruction for returning to the main program, and that whatever the input address in this sub-program, the execution of said instruction for returning returns to the main calling program at the instruction immediately following the instruction having caused said branching to the sub-program, to randomize a total execution time of the main program.

2. The method of claim 1, wherein the sub-program has a feature that whatever the input address in this sub-program, the instruction for returning to the main calling program is necessarily reached.

3. The method of claim 1, wherein said sub-program has a feature of containing no interrupt-generating operating code.

4. The method of claim 1, wherein said sub-program has a feature of containing no instruction for jumping or branching to an address external to said sub-program.

5. The method of claim 1, wherein said sub-program has a feature of containing no infinite loop.

6. The method of claim 1, wherein said sub-program is placed, with the code of the main program, in a ROM.

7. An integrated circuit for executing a deterministic program, comprising means for executing the antifraud method of claim 1.

8. An antifraud method for an integrated circuit executing a main program, comprising:
branching or jumping from the main program to a randomly-selected address in a sub-program; and
executing the sub-program from the randomly-selected address to an instruction for returning to the main program.

9. A method a defined in claim 8, further comprising resuming execution of the main program after returning from the sub-program.

10. A method as defined in claim 8, wherein the sub-program contains no instruction for jumping or branching to an address external to the sub-program, except for the instruction for returning to the main program.

11. A method as defined in claim 8, wherein the sub-program contains no infinite loop.

12. A method as defined in claim 8, wherein the sub-program contains no interrupt-generating code.

13. A method as defined in claim 8, wherein any code in the sub-program leads directly or indirectly to the instruction for returning to the main program.

14. A method as defined in claim 8, wherein executing the sub-program comprises jumping or branching to a second sub-program and executing the second sub-program to the instruction for returning to the main program.

15. An antifraud method for an integrated circuit executing a main program, comprising:
randomizing a total execution time of the main program.

16. A method as defined in claim 15, wherein randomizing the total execution time comprises branching or jumping from the main program to a randomly-selected address in a sub-program, executing the sub-program from the randomly-selected address to an instruction for returning to the main program, and resuming execution of the main program following returning from the sub-program.

17. A method as defined in claim 16, wherein the sub-program contains no instruction for jumping or branching to an address external to the sub-program, contains no infinite loop, and contains no interrupt-generating code.

18. A method as defined in claim 16, wherein the step of executing the sub-program comprises jumping or branching to a second sub-program and executing the second sub-program to the instruction for returning to the main program.

19. An integrated circuit comprising:
means for executing a main program;
means for branching or jumping from the main program to a randomly-selected address in a sub-program; and
means for executing the sub-program from the randomly-selected address to an instruction for returning to the main program.

20. An integrated circuit as defined in claim 19, further comprising means for resuming execution of the main program following returning from the sub-program.

21. An integrated circuit as defined in claim 19, wherein the means for executing the sub-program comprises means for jumping to a second sub-program and means for executing the second sub-program to the instruction for returning to the main program.

22. An integrated circuit as defined in claim 19, wherein any code in the sub-program leads directly or indirectly to the instruction for returning to the main program.
